(19) United States
(12) Patent Application Publication
(10) Pub. No.: US 2009/0192249 A1
(43) Pub. Date: Jul. 30, 2009

(54) Alcohol modified aqueous polyvinyl acetate suspension

(75) Inventor: Lawrence E. Bodkin, SR., Jacksonville, FL (US)

Correspondence Address: ARTHUR G. YEAGER, P.A., 245-1 EAST ADAMS STREET, JACKSONVILLE, FL, 32202-3336, US

(73) Assignee: Lawrence E. Bodkin,, JR.

(21) Appl. No.: 12/011,345

(22) Filed: Jan. 26, 2008

(51) Int. Cl. C08K 5/05

(52) U.S. Cl. 524/379

(57) ABSTRACT

An aqueous suspension of polyvinyl acetate, modified by at least one alcohol, renders its residual evaporative product insoluble; in that it does not disintegrate and tend to revert to an aqueous suspension when immersed or otherwise subjected to an excess of water, as does the unmodified product. The modified evaporative product, used experimentally as a shielding film that protects plants and fruit from insect damage, does not depend on toxicity for effectiveness, and maintains its integrity by stretching and thinning to accommodate plant growth without rupture to provide uninterrupted protection between applications. The shielding transmits moisture and is believed to transmit needed atmospheric gases as well, to provide long lasting, primarily mechanical protection. The modified suspension, and evaporative product, have demonstrated medicinal properties as a topical treatment for control of psoriasis. Transparent, colorless and odorless when dry, it is anti-bacterial, provides relief from itching and promotes healing of lesions.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO A “MICROFICHE APPENDIX.”

Not applicable

### BACKGROUND OF THE INVENTION

1. Field of the Invention

This invention relates to suspensions of polymer materials made to leave a residual substance upon evaporation of the suspending medium that can serve as a coating or as a cement. While this broad definition includes a great many preparations applied in a liquid form, this invention relates more specifically to an aqueous suspension of polyvinyl acetate that is most familiar to consumers as “white glue”. This suspension leaves an evaporative residual product that has a normally reversible quality when immersed or otherwise exposed to an excess of water, in that it has a tendency to revert to an aqueous suspension. The invention accomplishes a modification of the suspension and consequently a modification of the evaporative product to the extent that it does not tend to disintegrate and revert to an aqueous suspension when it is immersed or otherwise exposed to an excess of water, even for extended periods. While exposure to water does not dissolve the modified residue or evaporative product, it does cause it to absorb water, become softer, more pliable and capable of being slowly and easily stretched to a marked degree.

2. Background Information

Much attention has been given to the development of a means of “organic” agricultural insect control that would not constitute a hazard to human beings and livestock. As a result, predator insects and insectivores have been collected and successfully employed, but this appears to be a solution that is prohibitively expensive for general use.

The concept of mechanically shielding plant tissues from insect attack appears to be without precedent. There is no background information available regarding similar insect protection, only the indirect references to protection by insecticides or predators.

Considerable attention has also been given to the matter of psoriasis treatment. Psoriasis is generally considered to be an affliction caused by a genetic defect that affects the autoimmune system. It is frequently disfiguring and is believed to have been historically confused with leprosy. Psoriasis sufferers have tended to respond erratically to most treatments such as the traditionally recommended exposure to ultraviolet radiation and the use of topical preparations, usually containing foul smelling coal tar derivatives.

While often seeming to improve for short periods, the psoriasis patient's tendency to relapse is typical. Steroids have given remarkable results but are not advisable for long term use since they tend to thin the skin and is hazardous to the endocrine balance.

### DESCRIPTION OF THE INVENTION

The applicant's original work with the polymer suspension was directed toward finding a more economically practical solution to the problem of plant damage by insects and focused in a unique direction; on the development of a polymer shield that could protect all parts of a plant from insect damage in a largely mechanical manner and not rely on toxicity for effectiveness. While the deposited shield may provide some portion of its protection by being distasteful to insects, its primary intended purpose is to provide a surface that interferes with the working of insect mouth parts and thus thwart their attacks. The shield needed to be permeable to atmospheric gases and moisture, expandable enough to accommodate plant growth without retarding it and without rupture, becoming progressively thinner and less effective with plant growth, but providing a degree of protection that would be extended until the next application. Such a shield may protect against other surface assaults as well.

The shield needed to be transparent and colorless so as to avoid altering the plant appearance. It also needed to be odor free when dry, and non-toxic to humans in order to simplify food preparation and permit ingestion with the skin of fruits that are not generally peeled before consumption. While toxicity or the lack of it has not been clinically established for the modified polymer product, it retains many properties of the unmodified product, and there is no indication that it is not similarly non-toxic.

Extensive immersion tests of dried modified polymer samples were performed to confirm resistance to disintegration. During this time, it was noted that was a difference between the evaporative residue film, when freshly formed, and that which is redryed after extended aqueous immersion. That which is freshly formed from the alcoholically modified suspension is particularly soft, pliable and elastic, with a slow return after stretching and little force of return. After extended aqueous immersion and redrying, it was noted that the film was not so soft and was less pliable and easily stretched when in the dry state and required wetting to restore these desired properties. The applicant believes that the polyvinyl alcohol component of the glue was relatively unaffected by the alcohol modification and while the polyvinyl acetate suspension acquired a resistance to the disintegrating effects of water, the polyvinyl alcohol component remained soluble and was leached out during the immersion.

For one of many field demonstrations, a suspension to which methanol was the alcohol addition, was prepared. While this suspension could not be used on animal tissue, it was applied to the leaves of a Scheffiera plant, with a few leaves also being coated with the unmodified aqueous suspension to obtain a control comparison. The coated leaves were allowed to dry thoroughly and were then subjected to a few minutes of water spray to simulate rainfall. The coatings by the unmodified aqueous suspension turned an opaque milk-white in an apparent reconstitution of the aqueous (glue) suspension and could be wiped away or washed away with a moderate degree of water pressure. The coatings by the methanol modified suspension retained their integrity and remained resistive to reversion, showing no perceptible change other than a whitening in areas that were more thickly coated. The leaves could not be subjected to long term immersion testing, but after many weeks, and several wettings by natural rainfall and dew, the alcohol modified coatings remained intact, while the unmodified polyvinyl acetate coatings had disappeared. All leaves involved in the test retained their original healthy appearance and exhibited slight growth during the test period. The moisture provided by dew is generally adequate and facilitates expansion of the shielding polymer more frequently than rainfall.

While the shield may be applied by spraying an alcohol diluted version of the modified polymer and result in a reasonably uniform coating, on-going field tests involved using a isopropyl modified suspension, diluted by a 50% addition of isopropyl by volume, and coating both sides of selected leaves by hand to better accomplish a shielding uniformity. This shielding completely encased or encapsulated the leaves except for the stem and no III effects from such encasement have been noted. As expected, moisture from early morning dew is absorbed with a temporary whitening of the shield, made most notable where the shield is thicker. Such a completely enclosing shield, when applied as cold weather approaches, again makes use of the Scheffiera plant because it's evergreen quality makes leaves available for coating at this time of year, but also because it is cold sensitive and any beneficial effect of the shield with regard to protection from such things as wind-chill and frost can be readily observed if temperatures fall below freezing.

The film body deposited from the alcoholic modification of the polymer suspension is not soluble in water, but retains many properties of the unmodified polymer. A small amount of water causes a deposited, alcohol modified polymer film to soften and become more pliable and easy to stretch to a remarkable degree but even large amounts of water do not cause it to disintegrate. If the alcohol modified suspension is mixed with water, while still in liquid form, the modified polymer is precipitated and can be submerged indefinitely in the water without demonstrating a tendency to revert to an aqueous suspension or any other form of deterioration.

While working with the modified suspension the applicant found it to have remarkable medicinal value in control of psoriasis and to be superior to all other topical remedies.

In the use of his invention in treating psoriasis, the applicant not only found it to be a very effective alternative to conventional treatment, but more convenient to use, not distasteful or discomforting to endure, and with no apparent hazardous effect on health.

When the applicant found the invention particularly useful in promoting the healing of a patient's psoriasis lesions, it appeared to be effective to such an extent that he considered it a way to fully control the condition. In a singular test case, it caused remission to the point of effecting an apparent cure, in all but a few small and long established areas.

Psoriasis is said to be primarily due to genetic defect and “controlled” may always be a more accurate term than “cured”. New areas may develop from time to time and need to be eradicated by a continuing use of the medication. Newly appearing lesions have often been eliminated with as little as one or two applications. Presently, this use of the invention, as a treatment for psoriasis is scheduled to undergo formal dermatological testing.

While the modification of the aqueous suspension by the addition of an alcohol gives it a medicinal value that can be directly attributed to the alcohol's antimicrobial or antibacterial qualities, there also appeared to be a beneficial effect provided by the modified polymer and perhaps a synergistic effect, while in the liquid state, that involved both the alcohol and the modified polymer.

The subject patient suffered from both large patch and small area psoriatic lesions that affected over 55% of his skin surface at the time he was given the alcohol modified polymer suspension to try as a desperation measure.

The immediate results were astonishing. An intense itching was stopped and this meant that the dangers associated with infection of torn and bleeding skin caused by patient scratching could be avoided. While the residual film tended to peel more easily from healthy skin, it proved to be particularly adherent to lesions and capable of protecting the affected areas for long periods. Most preparations advised for treatment have been sticky, unsightly, ill smelling and difficult to remove from clothing. The fact that the modified alcoholic polymer suspension left a transparent, colorless, flexible film that was odorless and nearly invisible were welcome qualities and prompted extensive experimental use.

Prolonged use of the modified suspension allowed nearly all of the patients numerous and extensive lesions to heal over the next few months. A few of the oldest and most established areas, while considerably improved, proved recalcitrant enough to resist total eradication.

### BRIEF SUMMARY OF THE INVENTION

In a briefest of descriptions, an alcohol is added to an aqueous suspension or emulsion of polyvinyl acetate to obtain the desired modification. Although it serves to dilute the concentration of the polymer in the liquid form of the final product, addition of the alcohol transforms the thin paste-like consistency of the aqueous suspension into a gel or gel-like form of increased viscosity.

The alcohol addition is to be at least one from a group including, but not limited to, ethyl, methyl and isopropyl alcohols. These alcohols are miscible in all proportions and may be used singly or they may be combined if desired for any reason, with the reservation that methyl alcohol is not to be used if the modified suspension is to be applied to the skin or otherwise used on human or other animal tissue.

While the three alcohols have been the subject of various experiments, isopropyl alcohol has been the alcohol addition of choice due to such practical considerations as effectiveness related to cost.

An object of this invention is the modification of an aqueous suspension of polyvinyl acetate so that the evaporative product resists reversion to a suspended state when immersed or otherwise subjected to an excess of water and does not disintegrate.

An associated object is to have the evaporative product retain the susceptibility to water to the extent that it absorbs water.

Another associated object is to have the evaporative product retain the susceptibility to water to the extent that absorption of water, in such small amounts as provided by dew, can cause it to become softer, more flexible and capable of being easily stretched so that it can protect plants yet accommodate growth without restriction.

An additional object is to modify the aqueous suspension without increasing toxicity.

Another additional object is to modify the aqueous suspension to obtain beneficial medicinal properties.

A further object is to modify the aqueous suspension to obtain medicinal properties that are specifically beneficial in the treatment of psoriasis.

### BRIEF DESCRIPTION OF THE INVENTION

The modified polymer used for both plant protection and psoriasis treatment is prepared by adding alcohol to a standardized, readily available aqueous suspension of polyvinyl acetate, familiar to the public as the multipurpose white glue, also said to contain a polyvinyl alcohol, perhaps as a copolymer, merely as an emulsifier and most probably as both. While ethyl and methyl alcohols have been found effective in producing a residual product that is dissolution resistant in water, the preferred alcohol is a 91% isopropyl that is marketed for use in sterilizing hypodermics and other instruments as well as for use as a rubefacient. The use of methyl alcohol is limited to uses other than medicinal since it is an irritant and considered toxic. Denatured ethyl alcohol has been found usable but some may not be acceptable due to the nature of the denaturing substances. Use of ethyl alcohol in a potable grade is expensive.

The amount of alcohol required in preparation may generally be said to simply exceed the volume of the aqueous suspension so that an excess should be available before beginning the preparation process. Rather than being more specific in prescribing the relative quantities, when preparing small quantities by hand, it is more efficient to determine them by empirical means such as using an observation of achieved transparency as a relative quantity control. This is particularly true in light of the applicant's testing of random samples of the commercially available aqueous suspension in which considerable variation in properties was found, not in the manufacturer's intended usage as a glue, but when related to the applicant's special usage. It is apparent that both efficiency and uniformity in commercial production of the invention would be greatly improved if the total process included a production of the aqueous suspension as well, instead of attempting to rely on use of the suspensions from established commercial sources. Once a uniformity of ingredients can be assured, volumetric proportioning of suspension and alcohol can be accurately determined in advance to facilitate quantity manufacture.

There is a considerable difference in water contribution by the commonly available alcohols when they are used in preparation and this must also be included in considering the sources of variation in the product.

Isopropyl, at 91%, contains nearly 10% water and ethyl, at 153 proof, about 25%. Methyl, due to its method of manufacture, is commonly obtainable as a relatively pure product, containing substantially no water. All alcohols are available in a relatively pure state, from industrial sources, and while desirable are not readily available nor required.

In a preferred procedure, under present conditions in which most commonly available aqueous suspensions and alcohols do not vary markedly, the process calls for adding the alcohol to the suspension, slowly and in small quantities, while stirring constantly until the alcohol is fully incorporated into the mass, which should become an homogenous whole before adding more alcohol. As the addition of the alcohol continues, the mixture will first begin to thicken and be more resistive to stirring, then slowly become less resistive. As more alcohol is added the mixture becomes less white and more translucent, finally becoming substantially transparent and water clear. At this point, addition of alcohol may be discontinued and after a brief continuation of stirring to assure uniformity, the preparation may be considered complete. In general, it is practical to add larger quantities of alcohol as preparation begins and successively smaller quantities as the preparation process nears completion. It is desirable to add alcohol after a sufficiency for modification has been reached, only if the viscosity of the suspension needs to be reduced to facilitate application by spraying.

While there seems to be an acceptable degree of uniformity in most of the commercial suspensions, there have been occasional instances in which a notable variation occurred. One sample, made in China, tended to form a gel state very quickly with an extremely high, quite stiff gel viscosity. Another sample, made in Canada exhibited a similar reaction but to a much less notable degree. The difference in these samples was strongly suspected to be attributable to a difference in molecular weight of the acetate polymer although the possible presence of a contaminating agent could not be excluded. White glue formulations contain polyvinyl alcohol, perhaps as an emulsifier for the acetate, but possibly as a copolymer as well and its presence cannot be ignored as a factor.

The increased rate of gel formation and increased viscosity caused by the anomalous suspensions does not interfere with the product resistance to disintegration in immersion.

The gel appears water clear as the modifying procedure becomes complete, just as when the typical suspension is used. More alcohol can be used to reduce the viscosity, but it has been noted that adding and mixing the additional alcohol can cause the water clear gel to become clouded by bubbles.

The variation in the gel is produced without change in the modifying process, and is due to a variance in the polyvinyl acetate suspension. The higher viscosity product is not considered to be without value, nor to be beyond the scope of the applicant's invention. This variance from the commonly encountered suspension is believed to be fully capable of duplication when desired, once the reason for it is established. The higher viscosity product would require marketing in a large mouth salve-type container or in a collapsible toothpaste-like tube rather than a dispenser bottle.

While an aqueous suspension of polyvinyl acetate is said to slowly react with water and deteriorate over time, such deterioration is not believed to be responsible for the above described variations. In another consideration of shelf life, experiments with the alcohol modified polyvinyl acetate suspension, made and stored in the liquid state for an extended period, indicate that it is remarkably stable. No deterioration was noted. Once modified by the disclosed treatment with an alcohol, any deterioration of the polymer is either reduced in rate or doesn't occur to any appreciable degree.

The subject patient suffered from large patch lesions as well as small ones, with at least 45% of his skin area, and often as much as 55%, being simultaneously affected during the last twelve years. He had tried the dermatologist's variously prescribed medications in salve and ointment or cream form, most including greases and coal tar to treat the condition and with the addition of salicylic acid, to assist in plaque removal. Other more quickly effective preparations have relied on the inclusion of steroids. Treatment with steroids was effective but apparently worked by slowing skin growth to control the over-growth of plaque production but also had the side effect of causing a thinning the skin. Steroids could also have a systemic affect in upsetting the endocrine balance if used on large areas that permitted substantial absorption. The patient also tried the highly advertised cures, one with Dead Sea-Salt and others with “secret” ingredients. None of these were appreciably effective. After approximately three months of using the modified polymer suspension on a weekly basis, all large areas appeared cured and only small areas, although greatly improved, continued to remain.

The modified polymer is odorless when dry, and relatively invisible where it adheres strongly to affected areas, although it tends to make such areas slightly shiny. Large nearly healed areas may have small shiny spots that remain before healing is complete. It has been found advisable to continue application to recently healed areas for a briefly extended period because of these tiny, still remaining, afflicted spots that may be difficult to detect, except by the ready adherence of the modified polymer. This characteristic that differentiates between afflicted and healthy skin may permit the modified polymer to be used as a psoriatic diagnostic tool.

Because the modified polymer tends to separate readily from healthy skin, especially after perspiring, excess applied to unaffected areas can be expected to detach as a film when fully dried. These detachments can become noticeable on areas that are to be visibly exposed, but the detaching, dry film is easily rubbed away.

The modified polymer acts to prevents the production of plaque and allows the body to heal the affected areas and thereby restore normalcy. The length of time it takes to restore normal skin conditions is primarily governed by the rate of the body's healing capability. In general the condition will be much improved within a few weeks, but several months will be required before large areas become completely healed. Particularly recalcitrant lesions may include small areas that will take even longer. Perhaps the most immediately notable factor in initial use is that the condition is immediately blocked from worsening and itching is largely alleviated.

In applying the modified suspension to the skin, it should be dispensed from a convenient applicator bottle that will permit small quantities to be dispensed as needed. The applicator cap should be of a type that does not allow material to dry in the dispenser opening so that clogging is avoided. Close fitting latex, vinyl or nitrile gloves should be used to avoid the difficulty of removing excess polymer from the fingers, while maintaining the sense of touch necessary for proper application. The applicant has found the vinyl and nitrile gloves to be particularly suitable. If bare fingers are used, the dried polymer can be removed by first wetting the fingers thoroughly. The medication does not wash off, but can be rubbed and rolled off, like rubber cement, after wetting. However, if large areas are to be treated, a considerable residue may be accumulated on the unprotected hands and fingers, and gloves are strongly recommended to save the aggravation and effort of removal.

In application, there is an initial lubricating-gel quality and the medication can be easily and smoothly spread and massaged into the affected areas of the skin. As it begins to dry and becomes resistive to spreading, any attempt to continue spreading should be immediately stopped to avoid rubbing and rolling the material away from the skin and irritating the tissues. Only a minute or two of drying time is required after application, if the area will not be covered. If the area will be covered by clothing, additional drying time is required in order to avoid adherence to the material, but this additional time seldom exceeds ten minutes. When applying to several areas, apply first to those areas that will be covered by clothing so that they may benefit from the additional drying time made available while the modified suspension is being applied to the other areas.

The modified polymer suspension should be applied, after bathing, and after the skin has had time to dry. Previous applications can be rubbed away in the bath or by a brisk toweling before making a fresh application. If larger plaques are present and appear to be loosened, they may be gently removed. If no points of bleeding are observed others may be tried as well, but when any pinpoints of bleeding occur after removal, plaques are not ready for a removal that will not hinder healing. Increasing the frequency of bathing, requiring more frequent applications of the medication does not seem to appreciably speed skin recovery, since an individual's own rate of healing is the primary determining factor.

Application to the scalp can be expected to stiffen and join the hair shafts. However, if users have lesions at the nape of the neck, where the hair is fairly short, this could be a good trial area for them, since any resulting odd hair appearance should be less noticeable. Once the efficacy of the modified suspension has been noted by a patient, severe lesions of the scalp may warrant removal of the hair in the affected area to facilitate treatment.

The properties of the modified polymer suspension and those of the residual evaporative product include characteristics that expand the possibilities of the polymer's usefulness. The modified suspension has demonstrated value in the treatment of psoriasis. Water resistance of the modified evaporative product, combined with moisture enhanced conformability makes a deposited film useful as an insect shield. This water resistance that prevents dissolution may enhance performance in many of the areas in which the polyvinyl acetate suspension has been found useful, providing that the alcoholic content is not found objectionable. All of the above is important in conferring the attributes of novelty in structure and function to the applicant's invention.

While the invention has been described with respect to certain specific embodiments, it will be appreciated that many modifications and changes may be made by those skilled in the art, without departing from the true spirit of the invention. It is intended therefore, by the appended claims, to cover all such modifications and changes as fall within the true spirit and scope of the invention.

1. In an aqueous suspension of polyvinyl acetate, the improvement comprising modification of said suspension by adding at least one alcohol that effectively renders an evaporative residue of said modified suspension insoluble and resistive to diintegration when immersed or otherwise exposed to an excess of water, wherein said adding of said at least one alcohol is continued until the opaque milk-white color of the unmodified suspension becomes water-clear.

2. The suspension as defined In claim 1 in which said suspension includes a polyvinyl alcohol and said addition of at least one alcohol is at least one alcohol from a group comprising ethyl, methyl and isopropyl alcohols.

3. An improved polymer comprising an aqueous suspension of polyvinyl acetate modified by adding at least one alcohol thereto until the opaque milk-white of the unmodified suspension has changed to water-clear, said polymer being obtained by removal of said at least one alcohol, said polymer being resistive to disintegration while retaining its physical integrity when immersed in, or otherwise subjected to, an excess of water.

4. The polymer as defined in claim 3 wherein said suspension of polyvinyl acetate contains a polyvinyl alcohol.

5. The polymer as defined in claim 3, wherein the said at least one alcohol is from the group comprising ethyl, methyl and isopropyl.

6. A polyvinyl acetate polymer comprising an aqueous suspension of said polyvinyl acetate modified by adding at least one alcohol thereto, said modified suspension forming an evaporative residue which is resistive to disintegration when immersed in, or otherwise subjected to, an excess of water, said modified polymer acting to relieve itching of the skin.

7. The polymer as defined in claim 6 wherein said suspension of polyvinyl acetate contains a polyvinyl alcohol.

8. (canceled)

9. (canceled)

10. The suspension as defined in claim 1 in which said at least one alcohol is isopropyl alcohol.

11. The suspension as defined in claim 1 in which said at least one alcohol is ethyl alcohol.

12. The suspension as defined in claim 1, wherein water makes an evaporative reside of said modified suspension highly pliable and easily stretched so that said residue may accommodate growth when used to protectively coat plants.
